(19) United States
(12) Patent Application Publication
(10) Pub. No.: US 2004/0213147 A1
(43) Pub. Date: Oct. 28, 2004

(54) Environmentally hardened remote DSLAM

(76) Inventors: John Edward Wiese, Colorado Springs, CO (US); Matthew David Alspaugh, Denver, CO (US); Frank William Masa, San Jose, CA (US)

Correspondence Address: FLEHR HOHBACH TEST, ALBRITTON & HERBERT LLP, FOUR EMBARCADERO CENTER, SUITE 3400, SAN FRANCISCO, CA, 94111-4187, US

(21) Appl. No.: 09/769,852

(22) Filed: Jan. 25, 2001

(51) Int. Cl. H04J 1/16; H04L 12/28

(52) U.S. Cl. 370/216; 370/400; 370/395.1

(57) ABSTRACT

An improved communications system for servicing customers that are already partially serviced by an established backhaul connection, but which need an alternate and improved connection for broadband services. In established systems, customers are connected through access points using an established backhaul transport to an established central office. The alternate connection includes a remote digital subscriber line access multiplexer (R-DSLAM) connected to the established access points. The R-DSLAM connects with a new and alternate connection, between the R-DSLAM and the established office in parallel with the established backhaul transport and/or the R-DSLAM connects to a different remote office or other locations in communications networks. The R-DSLAM is environmentally hardened for all-weather outdoor installation and mounting on a utility-pole.

### BACKGROUND OF THE INVENTION

The present invention relates to the field of communications systems and methods and apparatus for connecting broadband digital services to customers and particularly to telephone customers serviced through established local loops.

In the United States, and similarly in other countries of the world, service providers deliver communications services to customers and particularly to their telephones, computers and other customer premises equipment (CPE). The services, including voice and data, are often provided through wire pairs running over at least a portion of the distance between a telephone company central office (CO) and the customer premises (CP). The wire pairs provide telephone POTS (Plain Old Telephone Service) to the customers. Those wire pairs have access points (sub-loop access points) at which connections to the customer wires can be made. In some telephone systems, sub-loop access points include Digital Loop Carriers (DLCs), Service Area Interfaces (SAIs), Digital Access (DA) points and other points which allow connections to the telephone POTS (Plain Old Telephone Service) connections. Local concentrators such as DLCs, are installed at locations remote from central offices (COs) to consolidate customer lines at those remote locations. At the local concentrators, customers are concentrated and connected to backhaul transports. The backhaul transports connect between the subloop access locations and the CO. Historically, DLCs, by concentrating lines, have reduced the cost for servicing customers. Presently, the areas servicing customers through concentrators include suburbs and new business complexes that are growing faster than other areas serviced by service providers.

The advent of tele-commuting, branch-office connectivity and customer Internet access has created a large demand for high-speed digital access for customers including those customers serviced through local access points, local concentrators and POTS lines. Generally, legacy equipment, including local concentrators, does not have the capacity to satisfy the demand for new high-speed digital access.

A Digital Subscriber Line (DSL) service is being offered by telephone companies to satisfy the need for high-speed digital access. The DSL service offers high-speed data access, operates using many parts of the existing wired infrastructure, supports traditional POTS traffic and reduces congestion by removing data traffic from the incumbent public switched telephone network (PSTN).

Legacy DLC concentrators were designed to provide satisfactory voice services. Because a large amount of data, relative to that required for voice only, must be transmitted for non-voice digital needs, DSL services have not been adequately supported by legacy voice systems. Many installed concentrators do not support DSL and it is estimated that only a small number of installed non-DSL-compatible local concentrators have been upgraded to DSL compatibility. Although newer local concentrators offer greater bandwidth, they still are not well engineered for data services. Further, configuring existing equipment for DSL service usually constrains the capacity for POTs service and introduces other problems at subloop access points.

It has been estimated that presently about 20 percent of all telephone customers receive services through local concentrators. In the future, it is likely that DSL services to customers connected through local concentrators will account for significantly more than 20 percent of new DSL deployment. With the increase in demand for digital services, a need exists for improved systems that are able to provide DSL and other broadband services to customers connected at subloop access locations of a telephone system.

DSL services have been typically deployed by installing a Digital Subscriber Line Access Multiplexer (DSLAM) in the telephone company central office (CO). The DSLAM facilitates the transmission of DSL data traffic between DSL modems, located at customer premises (CP), and a wide-area network (WAN). While this connection can be satisfactory when no local concentrator is present, DSLAMs located at the CO generally cannot send traffic directly to customer modems for customers serviced through DLC local concentrators because of insufficient capacity of the legacy equipment or because of poor POTS line quality resulting from long distances from a CO or other conditions.

In order to provide DSL services to customers of a telephone system, remote DSLAMs (R-DSLAMs) have been proposed, but they have not been widely adopted because of projected high installation costs and inadequate backhaul bandwidths.

The proposals for remote DSLAMS contemplate moving the DSLAMs located at a CO to a Remote ground-based cabinet installed in the field. The R-DSLAM locations are typically close to an existing DLC local concentrator. The R-DSLAMs operate to control the DSL data traffic between the DSL customer premises and a WAN or CO. The proposals for R-DSLAMs have required rack mounting in controlled-environment vaults (CEVS) on concrete pads shared with or near a DLC.

Unfortunately, the R-DSLAM proposals have been expensive because, among other things, they have required substantial and cumbersome new ground-based physical cabinets, external to existing DLC cabinets, and require substantial increases in backhaul bandwidth. Such new cabinets require a right-of-way, concrete for a pad, installation of the cabinet, power connections and the deployment of cross connect wiring to and from an existing DLC. Estimator's have concluded that R-DSLAMs will never be cost justified.

In consideration of the above background, there is a need for improved communications systems that achieve the objectives of scalability, interoperability and low cost of installation.

### SUMMARY

The present invention is an improved communications system for servicing customers that are already partially serviced by an established backhaul connection, but which need an alternate and improved connection for broadband services. In established systems, customers are connected through access points using an established backhaul transport to an established central office. The improved alternate connection of the present invention includes a remote digital subscriber line access multiplexer (R-DSLAM) connected to the established access points. Further, the R-DSLAM connects with a new and alternate connection, between the R-DSLAM and the established office in parallel with the established backhaul transport and/or the R-DSLAM connects to a different remote office or other locations in communications networks.

In particular embodiments, the R-DSLAM is environmentally hardened. For example, the R-DSLAM is all-weather hardened for outdoor installation and mounting on a utility-pole.

In typical embodiments, the R-DSLAMs include processor units, ATM assembler and disassembler units and ATM switch fabrics and the R-DSLAMs each include a master unit and one or more trunk interface units. Typically, the master unit is in all-weather hardened in a master enclosure and the trunk interface units are all-weather hardened and each is in a trunk interface enclosure.

The alternate backhaul transport includes an interconnection network that has a mesh or other configuration. The interconnection network is in one embodiment a wireless network of ATM switches that provides redundancy and increased capacity in the backhaul transport. Therefore, the interconnection network is well suited for providing broadband services to customers.

The foregoing and other objects, features and advantages of the invention will be apparent from the following detailed description in conjunction with the drawings.

### BRIEF DESCRIPTION OF THE DRAWINGS

FIG. 1 depicts a communications system with connections at subloop access points between a Central Office (CO) and Customer Premises (CP) and with an alternate backhaul connection including a remote DSLAM and an alternate backhaul transport.

FIG. 2 depicts further details of the communications system of FIG. 1 with networked remote DSLAMs connected at SAI and subloop access points.

FIG. 3 depicts the details of remote DSLAMs employed in the FIG. 1 and FIG. 2 systems.

FIG. 4 depicts the details of a trunk interface employed in the remote DSLAM of FIG. 3.

FIG. 5 depicts a pole-mounted, environmentally hardened embodiment of a remote DSLAM and an alternate backhaul connection.

### DETAILED DESCRIPTION

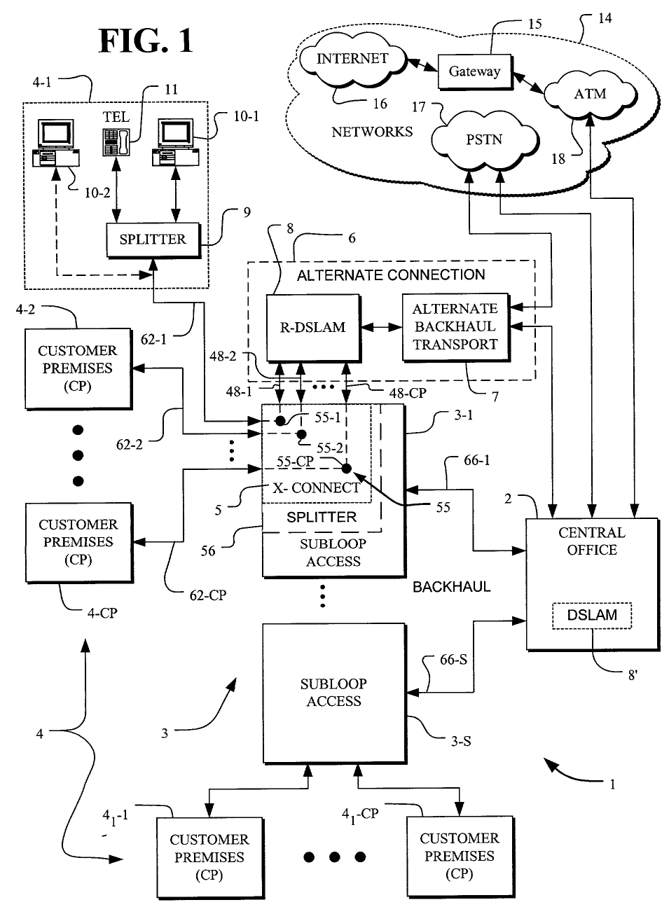

FIG. 1 depicts a communications system 1 with connections at access points 55, including access points 55-1, 55-2, . . . , 55-CP that are close to or at customer premises 4. The customer premises 4 receive broadband services over an alternate backhaul connection 6 that includes a remote DSLAM (R-DSLAM) 8 and an alternate backhaul transport 7. The R-DSLAM 8 connects to the access points 55 and hence to the local lines 62, including local lines 62-1, 62-2, . . . , 62-CP.

In the communications system 1 of FIG. 1, the central office 2 connects to the subloop access units 3-1, . . . , 3-S using established backhaul transport connections 66-1, . . . , 66-S. The subloop access units 3 typically are subloop access points 55 of a conventional telephone system. The subloop access point 3 connect to customer premises 4 including customer premises 4-1, 4-2, . . . , 4-CP and 4,-1, . . . , 4₁-CP,. The customer premises 4-1 is representative and includes, for example, a computer 10-1, a telephone 11 and a computer 0-2. A customer premises 4 can include any number of telephones, computers or other similar communication devices. In the customer premises 4-1 example, the local line 62-1 from the subloop access unit 3-1 as a data line connects directly to computer 10-2 or alternatively as a voice and data line connects through a splitter 9, for splitting voice and data, to the telephone 11 and the computer 10-1. Any combination of voice and/or data lines can be connected at a customer premises 4 using standard components to segregate voice and data at the customer premises 4, at the subloop access 3or elsewhere in the communications system.

In FIG. 1, the customer premises 4-1,4-2, . . . ,4-CP connect, on local lines 62-1, 62-2 , . . . , 62-CP, respectively, to the subloop access unit 3-1. When required, a splitter is located at the customer premises, such as splitter 9 at customer premises 4-1, at the subloop access points such as splitter 56 at subloop access 3-1 or elsewhere in the communications system. The splitter can also be located in the subloop access unit 3-1. Similarly, the customer premises 4-1, . . . , 4-CP, connect to the subloop access unit 3-S. The subloop access units 3, including subloop access units 3-1, . . . , 3-S represent access points in the communications system of FIG. 1 in local areas (local loop) near the customer premises. Access points can be at DLCs, SAIs and particularly can be at any points where connection to customer lines exists, including being at the customer premises.

Each of the subloop access units 3-1, . . . , 3-S in the embodiment of FIG.1 connects to a central office 2 over established backhaul lines 66-1, . . . , 66-S, respectively. The central office 2 is an office that centralizes communication tasks and connections for local customers and is typically a well known Incumbent Local Exchange Carrier (ILEC) central office.

In FIG. 1, the central office 2 connects to the networks 14. The networks 14 include, by way of example, a PSTN network 17 and a remote ATM network 18. The ATM network 18 in turn connects through a gateway 15 to the internet 16. The networks 14 can include any combination of public or private networks.

In FIG. 1, the subloop access unit 3-1, in addition to the established backhaul connection 66-1 to central office 2, has an alternate backhaul connection 6. The alternate backhaul connection 6 includes a R-DSLAM 8 and a backhaul transport 7. The R-DSLAM 8 connects through lines 48, including lines 48-1, 48-2, . . . , 48-CP, to the cross connect (X-CONNECT) unit 5, having the access points 55, in the subloop access unit 3-1. When required and when available, the connections through access points 55 can be split by a conventional splitter 56.

The R-DSLAM 8 functions to provide broadband services to the customers, at the customer premises 4 of FIG. 1, through the alternate backhaul transport 7. The R-DSLAM 8 in FIG. is functionally like a conventional DSLAM 8′ located in a conventional ILEC central office 2 of a telephone company. The R-DSLAM 8 of FIG. 1 facilitates the transmission of broadband traffic between broadband modems, located at customer premises 4, and the central office 2 and/or to the network 14.

The manner of connection of the R-DSLAM 8 to local loop access points, such as access points 55 that exist in cross connect (X-CONNECT) unit 5 in subloop access unit 3-1, depends upon the nature of the access points available in the established communications system. The available access points may exist in cross-connection boxes made available by an ILEC or other access provider, and if so, the size and configuration of those cross-connect boxes determines the manner in which the R-DSLAM connects through the access points to the customer premises 4. Typically, an access provider places one or more cross-connect boxes close to a DLC cabinet where all the subscriber tip-ring pairs are cross-connected to the tip-ring pairs going to a remote terminal cabinet. Because DSL service can ride over the same pair of copper wires as POTS service, rerouting of at least some of the local service pairs may be required. Specifically, the pairs carrying DSL/POTS traffic must be routed to the where the POTS and DSL signals are split (See splitter 56 in FIG. 1). The POTS traffic is then routed back to the cross-connect for connection to the DLC cabinet.

A limitation often arises with cross-connect configurations because available cross-connect boxes are usually designed to support the number of pairs that the DLC supports, with only limited spares. Thus, with the additional cross-connections that may be needed to support the R-DSLAM 8, it may be necessary to add cross-connects or resize the existing ones. The situation is compounded further in cases where remote terminals have incorporated the use of multiple cross-connect boxes because there may not be any way to forecast accurately which subscribers will want to add DSL services.

In FIG. 1, the access points 55 include, byway of example, the access points 55-1, 55-2, . . . , 55-CP in cross connect unit 5. In a typical example, the local lines 62-1, 62-2, . . . , 62-CP are POTS pairs that connect to corresponding pairs 48-1, 48-2, . . . , 48-CP from the R-DSLAM 8 at access points 55-1, 55-2, . . . , 55-CP.

Although access points 55 of FIG. 1 often are located in existing equipment away from the customer premises, increasingly there is a need for access closer to customers and at times at the customer premises. For example, where the customer premises are multiple units (Multi-Us) having many customer connections within the same building, complex or campus, the access points and/or the R-DSLAMs are in or near the Multi-Us.

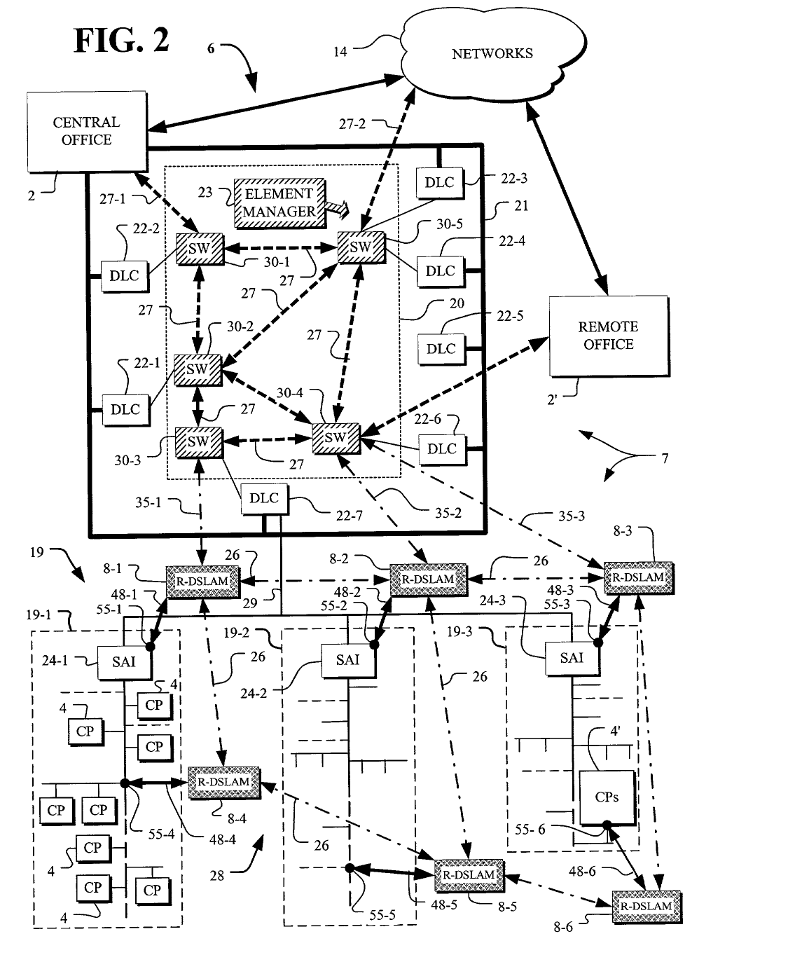

FIG. 2 depicts further details of the communications system 1 of FIG.1 with the R-DSLAMs 8 connected to access points 55 at SAIs 24 including points 55-1, 55-2 and 55-3 at SAIs 24-1, 24-2 and 24-3, respectively, and to other subloop access points 55 remote from the SAIs 24 and closer to the customers 4 including points 55-4 and 55-5 closer to customers in subloops 19-1 and 19-2, respectively. In some instances, the access points and/or the R-DSLAMs are located at the customer premises 4 as shown, by way of example, for access points 55-6 at multiple unit (Multi-U) CPs 4′. The R-DSLAMs 8 are interconnected by wireless transports 26 to form a local network 28. Additionally, the R-DSLAMs 8 connect through a backhaul network 20 formed of switches 30, including switches 30-1, 30-2, . . . , 30-5, interconnected by wireless transports 27. The backhaul network 20 connects to the central office 2, remote office 2′ and to the networks 8.

In FIG. 2, the central office 2 connects to a fiber optic loop 21 that connects to a plurality of subloop units including DLCs 22, namely DLCs 22-1,22-2, . . . , 22-7, and to the networks 14. The fiber optic loop 21 is part of the established backhaul transport connections 66 of FIG. 1. Each of the DLCs in FIG. 2 is an example of a subloop access unit 3 of FIG. 1. In FIG. 2, the DLC 22-7 is typical and shows the ordinary established connection to customer premises 4 though local subloops 19 including subloops 19-1, 19-2 and 19-3. The local subloops 19 are serviced through subloop access points 55 at Serving Area Interfaces (SAIs) 24, including SAIs 24-1, 24-2 and 24-3, corresponding to subloops 19-1, 19-2 and 19-3, respectively. The SAIs 24 connect the local subloops 19 over local connection 29 to the DLC 22-7 that in turn connects over the fiber optic backhaul loop 21 to the central office 2.

The customers 4 that are serviced by the subloops 19, by DLC 22-7 and by backhaul link 21 may be far away from the central office 2 or otherwise may not be able to be adequately serviced with DSL services directly by the CO 2. It is assumed for purposes of description that the backhaul link 21 connected to DLC 22-7, like that in an ordinary established telephone system, does not have enough capacity to provide DSL services from CO 2 to the customers 4 connected by local loop 19 including the subloops 19-1, 19-2 and 19-3. The customers 4 connected at local loop 19, including and subloops 19-1, 19-2 and 19-3, are typical of customers that are too far away from the CO 2 for DSL services, customers that are served by Digital Loop Carriers (DLC) 22 that cannot provide DSL services or customers that otherwise need added broadband capability.

In order to provide DSL or other broadband services, the alternate connection 6 of FIG. 1 provides the additional needed capacity and broadband capabilities to customers 4. In FIG. 2, the alternate connection 6 of FIG. 1 is implemented with R-DSLAMs 8 connected through an alternate backhaul transport 7 that includes backhaul network 20 of FIG. 2. In FIG. 2, the R-DSLAMs 8, including R-DSLAMS 8-1, 8-2, . . . , 8-6, connect to customers 4 through the SAIs 24, including SAIs 24-1,24-2 and 24-3 with access points 55-1, 55-2 and 55-3, respectively, and through other access points 55-4, 55-5 and 55-6.

To provide broadband services for the local area 19, the R-DSLAMs 8 of FIG.2 are located at the DLC site 22-7 or further out into the sub-loops 19-1, 19-2 and 19-3 of the network, at cross-connect boxes at Serving Area Interfaces (SAIs) 24, including SAIs 24-1, 24-2 and 24-3. These R-DSLAMs 8 provide broadband service and employ an alternate backhaul transport to carry the traffic to a point of presence such as central office 2, remote office 2′ or networks 14. In a typical embodiment, the central office 2 is a conventional ILEC central office and the remote office 2′ is a CLEC office. With such a configuration of ILEC and CLEC offices, the CLEC of remote office 2′ is able to provide broadband services to customers 4 without need for CLEC equipment in the ILEC central office.

In the embodiment of FIG. 2, a backhaul network 20 has a wireless mesh configuration that employs transports 27 to interconnect the ATM switches 30. The backhaul transports 27 use, in one embodiment, unlicensed radio bands combined with ATM switches 25 to provide a reliable network for the broadband backhaul. In one embodiment, a first ATM wireless radio network 20 is formed by a first plurality of wireless transports 27 interconnecting radio-capable ATM switches 30. In a further embodiment, a second ATM wireless radio network 28 is formed by a second plurality of wireless transports 26 interconnecting radio-capable R-DSLAMs 8. As an example, the wireless radio network 20 uses radio-capable ATMs with a 90 Mbps total data rate and the R-DSLAM wireless radio network 28 uses radio-capable ATMs with a 16 Mbps total data rate. The ATMs typically support ATM-25 and DS3 interfaces. The wireless transports 26 and 27 typically use unlicensed radio bands. While wireless transports 26 and 27 are preferred for ease of installation of networks 20 and 28, wired fiber or any other transport may be employed where desirable.

The networks 20 and 28 provide redundant connections in the backhaul transport. For example, a customer at CP 4 connected to the access points 55-4 in the subloop 19-1 connects via lines 48-4 to the R-DSLAM 8-4. From R-DSLAM 8-4, the backhaul connection in network 28 maybe routed through R-DSLAM 8-1 or R-DSLAM 8-5. From R-DSLAM 8-1, the connection may be routed through ATM switch 30-3 in network 20 or through R-DSLAM 8-2 in network 28 and from there directly to ATM switch 30-4 or to ATM switch 30-4 first by way of R-DSLAM 8-3. From the ATM switch 30-3 in network 20, the connection can be routed to ATM switch 30-2 or ATM switch 30-4. Similar redundant routing connections are available through network 20 to the central office 2, to the remote office 2′ or to the networks 14. This redundancy increases the reliability and availability of wideband services to customers.

The alternate connection 6 of FIG. 1 and FIG. 2, including R-DSLAMs 8 and alternate backhaul connection 7, is managed by the element manager 23 of FIG. 2. The element manager 23 maintains supervisory and control information about the backhual connection 7 including the wireless network 20 and the wireless network 28. In particular, element manager 23 maintains a database of switches 30, transports 27 and other equipment and facilities that are available and their operation status.

The network 20 of ATM switches 30 interconnects with the local network 28 of R-DSLAMs 8 using one or more third transports 35. In the FIG. 2 embodiment, R-DSLAM 8-1 connects by transport 35-1 to ATM switch 30-3, R-DSLAM 8-2 connects by transport 35-2 to ATM switch 30-4 and R-DSLAM 8-3 connects by transport 35-3 to ATM switch 30-4.

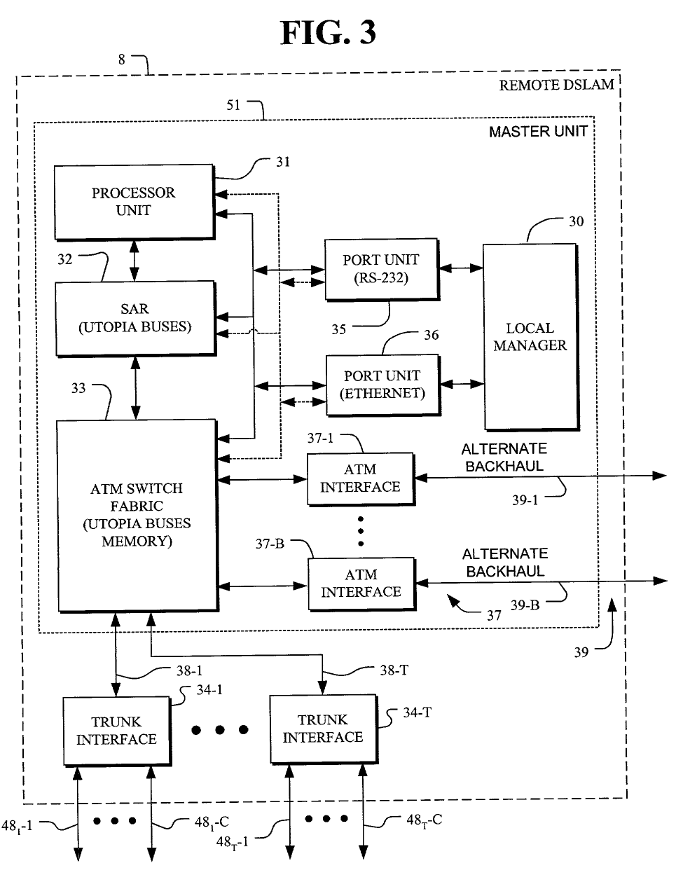

In FIG. 3, further details of a typical R-DSLAM 8 as depicted in FIG. 1 and FIG. 2 are shown. The R-DSLAM 8 includes a master unit 51 and one or more trunk interface units 34, including the trunk interface units 34-1, . . . , 34-T.

The master unit 51 includes a processor 31 which processes algorithms for operating the R-DSLAM. The processor 31 connects to an SAR 32 which functions to assemble and disassemble information into an ATM format. The SAR 32 interconnects with the ATM switch fabric 33 which functions to switch packets to customers, connected over the trunk interfaces 34 and the backhaul connections connected over the ATM interface 37. Local management of the master unit 51 is carried out by the local manager 30 connected through the port unit 52 (RS-232 format). The local manager 54 also interconnects to the processor 31, the SAR 32 and the ATM switch fabric 33 via port unit 36 (ETHERNET format).

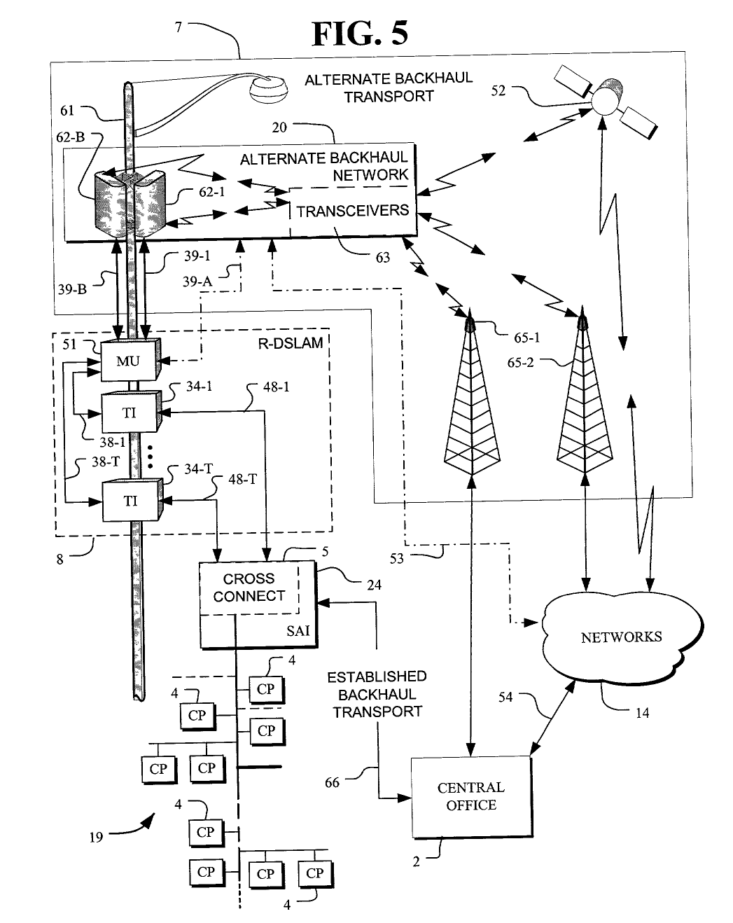

In FIG. 3, the ATM switch fabric 33 connects to the ATM interface 37, including ATM interface 37-1 and ATM interface 37-2 which in turn provide the alternate backhaul connection 39, including alternate backhaul connection 39-1 and alternate backhaul connection 39-2, respectively, which connects to the alternate backhaul transport 7 (see FIG. 1 and FIG. 5).

In FIG. 3, the ATM switch fabric 33 connects over the buses 38, including buses 38-1, . . . , 38-T, to the trunk interfaces 34. Any number of trunk interfaces 34 are possible and include, for example, the trunk interfaces 34-1, . . . , 34-T. Each trunk interface 34 has output connections for connecting to connection points in the telephone network. Specifically, trunk interface 34-1 has the output connections 48₁-1, . . . , 48₁-C. Similarly, the trunk interface 34-T has the output connections 48_{T}-1, . . . , 48T_{-C}.

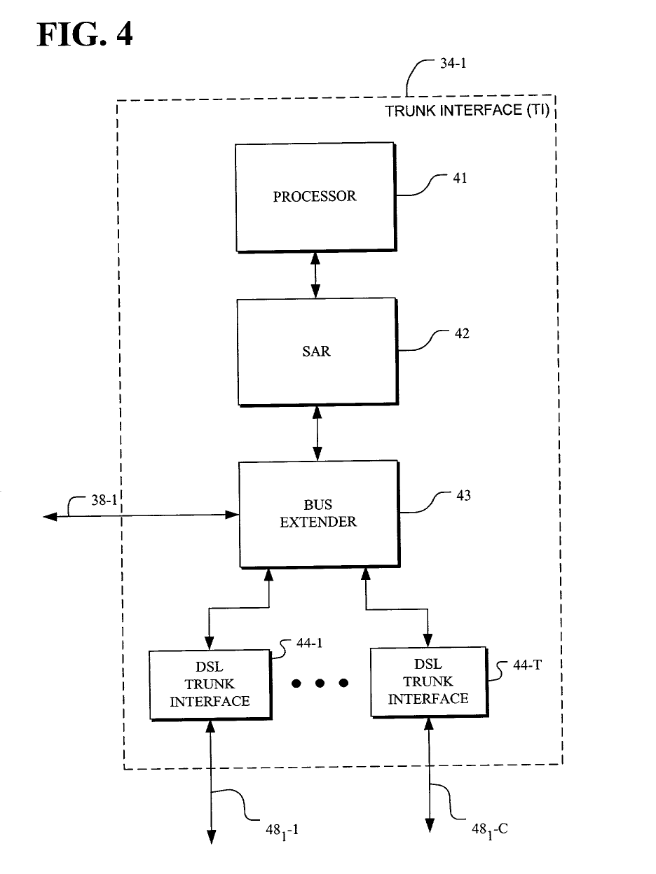

In FIG. 4, further details of a typical trunk interface for a R-DSLAM 8 are shown. Trunk interface 34-1 in FIG. 4 is typical of the trunk interfaces 34 of FIG. 3. In FIG. 4 the trunk interface 34-1 includes the processor 41 (like processor 31 in FIG. 3), the SAR 42 (like SAR 32 in FIG. 3) and bus extender 43. The bus extender 43 receives the bus 38-1 from the ATM switch fabric 33 of FIG. 3. The bus extender 43 provides the output to the connection interfaces 44, including connection interfaces 44-1, . . . , 44-T. Each of the connection interfaces 44-1, . . . , 44-T provides a corresponding connection output 48₋₁, . . . , 48₁-C.

FIG. 5 depicts an environmentally hardened, pole-mounted embodiment of a R-DSLAM 8 and an alternate backhaul transport 7. The R-DSLAM 8 has an environmentally hardened master unit 51 and trunk interfaces 34, including interfaces 34-1, . . . , 34-T, all mounted in enclosures on a utility pole 61. The alternate backhaul connection 39 from the R-DSLAM 8 connects to pole-mounted, all-weather, environmentally hardened transceiver units 62-1 and 62-B which form part of the alternate backhaul transport 7.

The term “environmentally hardened” is used to mean a property that permits devices to be located in normally adverse environments for electronic equipment. For example, when a device is to be located outdoors, the environmental hardening is for outdoor conditions that include rain, snow, wind, dust, sun and extreme temperature variations. When a device is to be mounted on a pole, the environmental hardening includes light weight and low power consumption. When a device is to be mounted in a corrosive environment, then corrosion protection is provided. When electromagnetic radiation must be accommodated, then RFI shielding or other suitable features are provided. The implementations of the R-DSLAM components in FIG. 3 and FIG. 4 are selected using conventional technologies to help achieve the level of environmental hardening required.

In the embodiment of FIG. 5, the transceiver units 62-1 and 62-B wirelessly communicate with the alternate backhaul network 20. Alternatively, the MU 51 of R-DSLAM 8 in other embodiments connects to the alternate backhaul network 20 using a wired connection 39-A. The alternate backhaul network 20 uses facilities including towers 65-1 and 65-2, by way of example, or alternatively uses a wired connection 53. One alternate backhaul connection, using tower 65-1, connects to a remote office which is the central office 2 and another connection, using tower 65-2, connects to the networks 14. Alternate backhaul 7, in another embodiment, uses satellite 52 and/or wired connection 53 to connect to networks 14. The networks 14, as described in connection with FIG. 1, include any combination of private or public networks.

In ATM network 18 which connects through a gateway 15 to the internet 16. In FIG. 5, at the local end, the R-DSLAM 8 connects to the cross connect 5 through output pairs 48-1, . . . , 48-T within the transport interfaces (TI) 34-1, . . . , 34-T. The cross-connect 5 in SAI 24 has established access points which connect to customer premises in the local loop 19. The SAI 24 also has established backhaul transport 66 to the central office 2. The alternate backhaul transport 7 is typically implemented as switching network 20 and local network 28 of FIG. 2. Each of the R-DSLAMs 8 in FIG. 2 may have a configuration like that of FIG. 5 or variations thereof.

The radios, the switches, and the R-DSLAM, in the FIG. 5 embodiment, are designed for all-weather, outdoor, pole-mounted or other non-ground-contact installation to simplify the deployment process and render the alternate connection 6 for broadband services within the local loop environmentally hardened and practical.

The R-DSLAM's preferable include ATM technology that enables touch-free provisioning features desired by the carriers. The touch-free provisioning is supported by the element manager 23.

Incumbent Local Exchange Carriers (ILECs) are able to use the R-DSLAM alternate connection 6 of FIG. 1 and FIG. 2 to provide DSL services in locations where DSL service is not otherwise easily provided.

Competitive Local Exchange Carriers (CLECs) are able to use the R-DSLAM alternate connection 6 of FIG. 1 and FIG. 2 to provide DSL services in locations where DSL service is not otherwise easily provided, particularly where it is difficult to obtain co-location with ILEC equipment to offer DSL on the ILEC loops such as fiber optic loop 21 of FIG. 2. The FIG. 2 system minimizes co-location to little more than connection at the cross-connects at subloop access points within the SAI's 24.

Power companies and others are able to use the R-DSLAM alternate connection 6 of FIG. 1 and FIG. 2 to provide needed telephone services since power companies already own much or the right-of-way required for a pole-mounted implementation of an alternate connection DSL service.

Multiple unit (Multi-U) customer premises, including multiple tenant units (MTUs) and multiple dwelling units (MDUs), are able to use the R-DSLAM alternate connection 6 of FIG. 1 and FIG. 2 to provide telephone services to their buildings.

The invention has been particularly shown and described with reference to preferred embodiments thereof it will be understood by those skilled in the art that various changes in form and details may be made therein without departing from the scope of the invention.

1. A communications system for servicing customers connected to access points and using an established backhaul transport to an office comprising:
one or more environmentally hardened remote digital subscriber line access multiplexers,
connecting means for connecting said access multiplexers to said access points,
an alternate backhaul transport for connecting said access multiplexers to provide broadband services to said customers.

2. The communications system of claim 1 wherein said access multiplexers are all-weather hardened for outdoor installation.

3. The communications system of claim 2 wherein said access multiplexers are located in utility-pole mountable enclosures.

4. The communications system of claim 1 wherein said access multiplexers include a processor unit, an ATM assembler and disassembler unit and an ATM switch fabric.

5. The communications system of claim 1 wherein each of said access multiplexers includes a master unit and one or more trunk interface units.

6. The communications system of claim 5 wherein said master unit is in an all-weather hardened enclosure and said trunk interface units are each in separate all-weather hardened trunk interface enclosures.

7. The communications system of claim 1 wherein said alternate backhaul transport includes a network of ATM switches.

8. The communications system of claim 1 wherein said alternate backhaul transport includes,
a plurality of ATM switches connected by a plurality of first transports to form a first network,
a plurality of second transports connecting said access multiplexers to form a second network,
a plurality of third transports connecting said second network to said first network.

9. The communications system of claim 8 wherein said first transports, said second transports and said third transports are wireless.

10. The communications system of claim 1 wherein said alternate backhaul transport includes a network of ATM switches supervised by an element manager.

11. The communications system of claim 1 wherein said alternate backhaul transport includes ATM switches connected by transports in a mesh network.

12. The communications system of claim 11 wherein said transports are wireless.

13. The communications system of claim 1 wherein said office is an ILEC central office.

14. The communications system of claim 1 wherein said alternate backhaul transport connects to a CLEC office.

15. The communications system of claim 1 wherein said alternate backhaul transport connects to other networks.

16. The communications system of claim 1 wherein said office is an ILEC central office and said alternate backhaul transport connects to a CLEC office.

17. The communications system of claim 1 wherein said office is an ILEC central office and said alternate backhaul transport connects to a CLEC office and to said ILEC central office.

18. The communications system of claim 1 wherein said office is an ILEC central office and said alternate backhaul transport connects to a CLEC office, said ILEC central office and to other networks.

19. The communications system of claim 18 wherein said other networks include the Internet.

20. A communications system for servicing customers connected to access points and using an established backhaul transport to an office comprising:
one or more all-weather environmentally hardened remote digital subscriber line access multiplexers in utility-pole mountable enclosures,
connecting means for connecting said access multiplexers to said access points,
an alternate backhaul transport for connecting said access multiplexers to provide broadband services to said customers wherein said alternate backhaul transport includes,
a plurality of ATM switches connected by a plurality of first wireless transports to form a first mesh network having redundant connections,
a plurality of second wireless transports connecting said access multiplexers to form a second mesh network having redundant connections,
a plurality of third wireless transports connecting said second network to said first network.

21. The communications system of claim 20 wherein said office is an ILEC central office and said alternate backhaul transport connects to a CLEC office, said ILEC central office and to other networks.
